(19) United States
(12) Patent Application Publication
(10) Pub. No.: US 2007/0200872 A1
(43) Pub. Date: Aug. 30, 2007

(54) GENERATING AN IMAGE SEQUENCE

(75) Inventors: Steve Bowie, Toronto, Ontario (CA); Rusty Mills, Agua Dulce, CA (US); Paul B. Ford, San Antonio, TX (US); Daniel J. Kraus, San Antonio, TX (US)

Correspondence Address: RICHARD M. GOLDBERG, 25 EAST SALEM STREET, SUITE 419, HACKENSACK, NJ, 07601, US

(73) Assignee: BRAUHAUS SOFTWARE, San Antonio, TX (US)

(21) Appl. No.: 11/677,249

(22) Filed: Feb. 21, 2007

Related U.S. Application Data
(60) Provisional application No. 60/775,074, filed on Feb. 21, 2006.

(51) Int. Cl. G09G 5/00

(52) U.S. Cl. 345/619

(57) ABSTRACT

A method and apparatus are provided for generating an image sequence, in which image elements are defined digitally. The method includes the steps of: defining the format of the image via a template system; generating thumbnail image data; transferring such thumbnail data into sequential storyboard panels for reference; drawing or editing resultant storyboards; inserting text for each storyboard; revising storyboards while preserving numbering; creating custom camera pans by employing both template presets and user input; formulating automatic page layout based on a variety of pre-set templates; printing the storyboards; and storing digital image data from the process in an image data format.

### BACKGROUND OF THE INVENTION

The present invention relates to previsualizing multimedia content (“Storyboarding”), in which a sequence of images is defined digitally as a visual reference to a storyline prior to actual final content creation.

Commercially-available 2D systems are capable only of producing “single image at a time”. While such tools can be used to create individual storyboards, they are highly inefficient for the creation of actual storyboard sequences, which are the basis of professional storyboard production.

A typical storyboarding workflow is shows in FIG. 1, in which thumbnails 101 and storyboards 102 are prepared by artists for review 103. Thumbnails are generally created as a base of reference, and are then “cleaned up” to produce a final storyboard for review.

In the general case, storyboards are either created and then used on paper, or created on paper and scanned into a commercially available editing system. The format and style of these boards is pre-established at the paper-level of the process.

This scanning process is costly, and provides only minimal convenience by converting the process to digital form for the sake of more expedient visualization, editorial modification and printing. A problem with the workflow is the definitive break between the original analog storyboards and the resulting digital content, especially if modifications to the storyboards are required once review is complete. A good deal of natural material (paper) is wasted as well; handling, storing and maintaining the paper originals for reference and updates is costly, time-consuming, and highly inconvenient.

### BRIEF SUMMARY OF THE INVENTION

According to an aspect of the present invention, there is provided a method of generating a image sequence, in which image elements are defined digitally, said method comprising the steps of: defining the format of the image via a template system; generating thumbnail image data; transferring such thumbnail data into sequential storyboard panels for reference; drawing or editing resultant storyboards; inserting text for each storyboard; revising storyboards while preserving numbering; creating custom camera pans by employing both template presets and user input; formulating automatic page layout based on a variety of pre-set templates; printing said storyboards; and storing digital image data from the process in an image data format.

### BRIEF DESCRIPTION OF THE SEVERAL VIEWS OF THE DRAWINGS

FIG. 1 shows a typical paper-based storyboarding workflow;

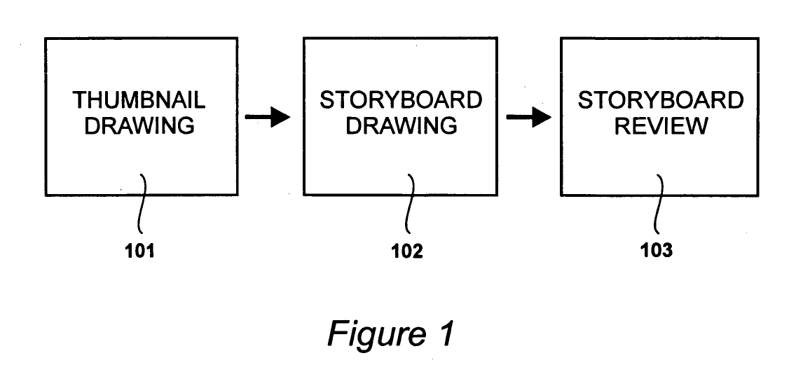

FIG. 2 shows an example of an environment in which the present invention may be used;

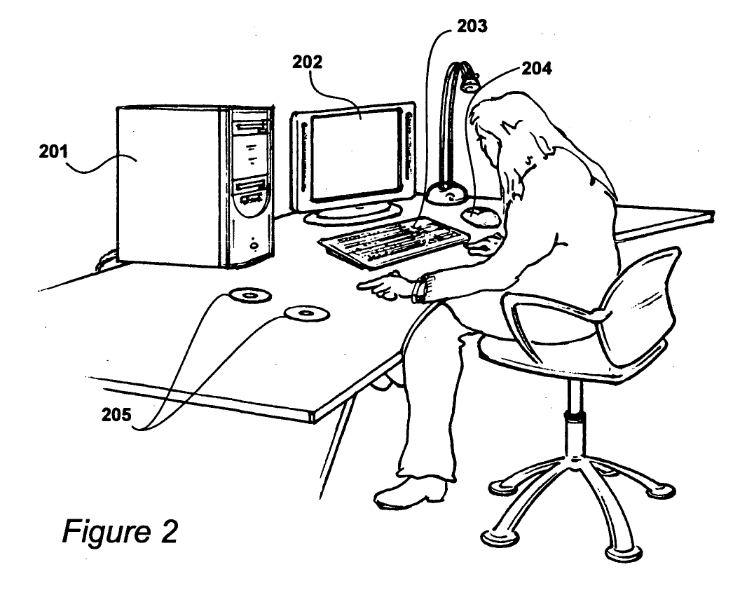

FIG. 3 shows a typical sheet of thumbnails;

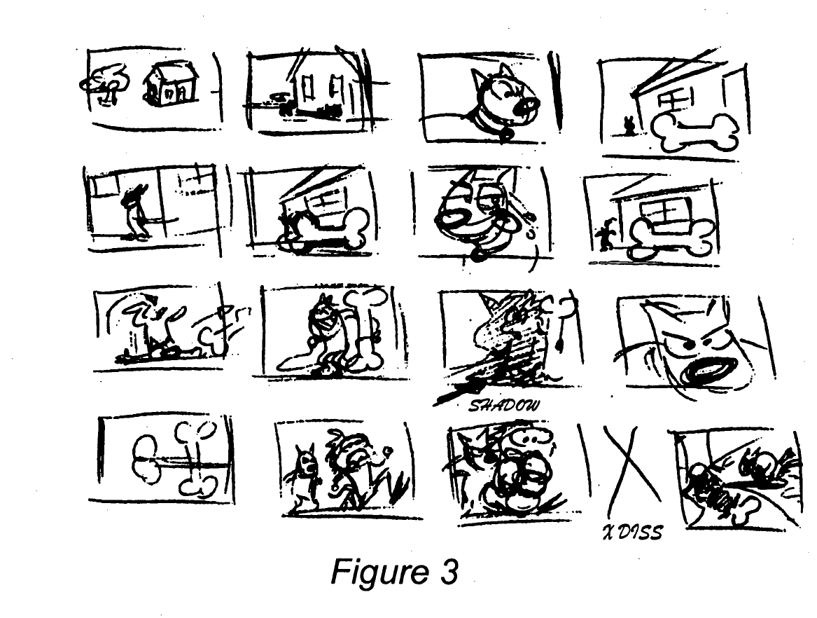

FIG. 4 shows a sample finished storyboard;

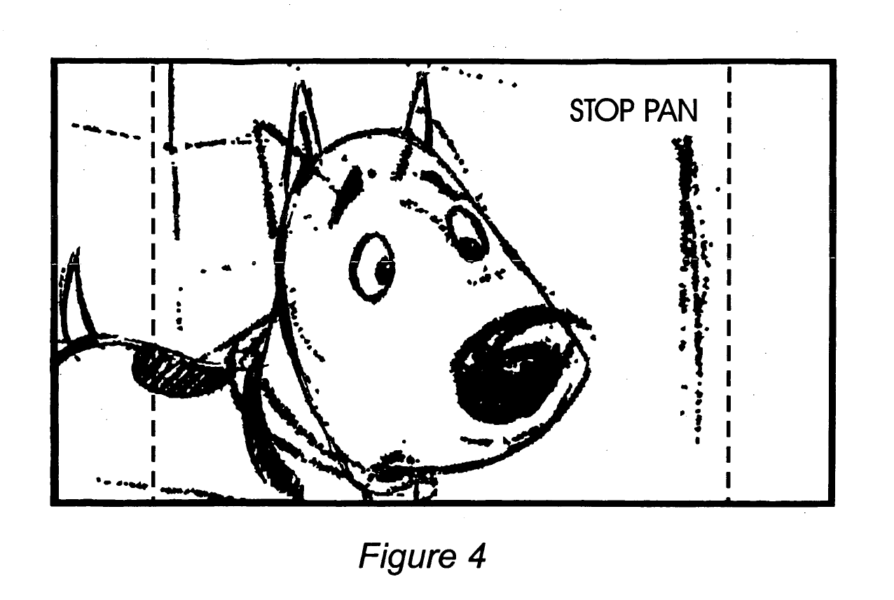

FIG. 5 shows a typical digital storyboard workflow according to the invention;

FIG. 6 illustrates generation of an animatic; and

FIG. 7 shows automatic generations of camera pans.

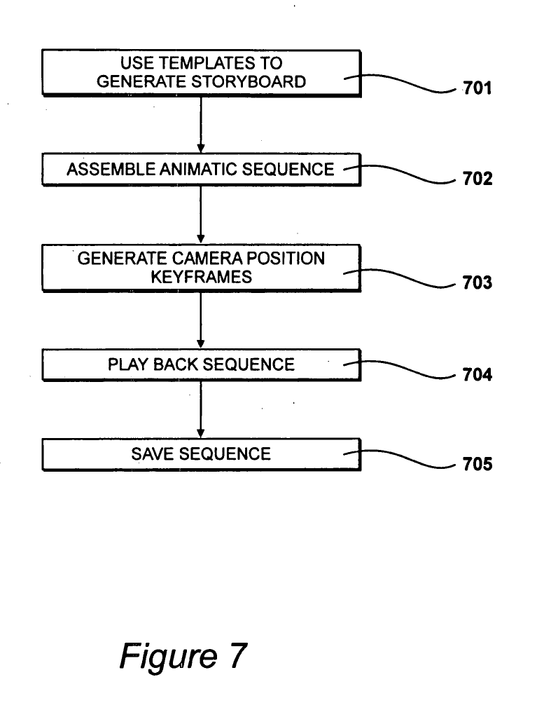

### WRITTEN DESCRIPTION OF THE BEST MODE FOR CARRYING OUT THE INVENTION

There is provided a method of generating one or a sequence of storyboards based on preset templates, in which storyboard elements are created digitally via drawing directly into a computer system or by scanning in paper drawings or a combination of both means, said method comprising the steps of: first defining the storyboard layout via a system of pre-set templates, drawing or scanning in small “thumbnail” representations of the individual drawings for final storyboards, transferring such thumbnails to the panels of the digital storyboard representation, modifying and editing such resulting storyboards digitally, designing and inserting oversize pan images and their associated camera movements and other timing effects, inserting dialog/actions/pan names and other numeric and textual data for each storyboard panel, automatically formatting the final sequence of storyboards for printing, printing the digital image data on a selected printer for the sake of review, and saving the final storyboard file to a disk or other storage medium.

A processing system 201 is configured to display output to a monitor 202, and to receive input from devices such as keyboard 203 and mouse 204. A plurality of DVDs 205 provide data and instructions to processing system 201 via a DVD drive 106. Storage is provided as part of processing system 201. The equipment illustrated provides an example of an environment in which the invention may be utilized.

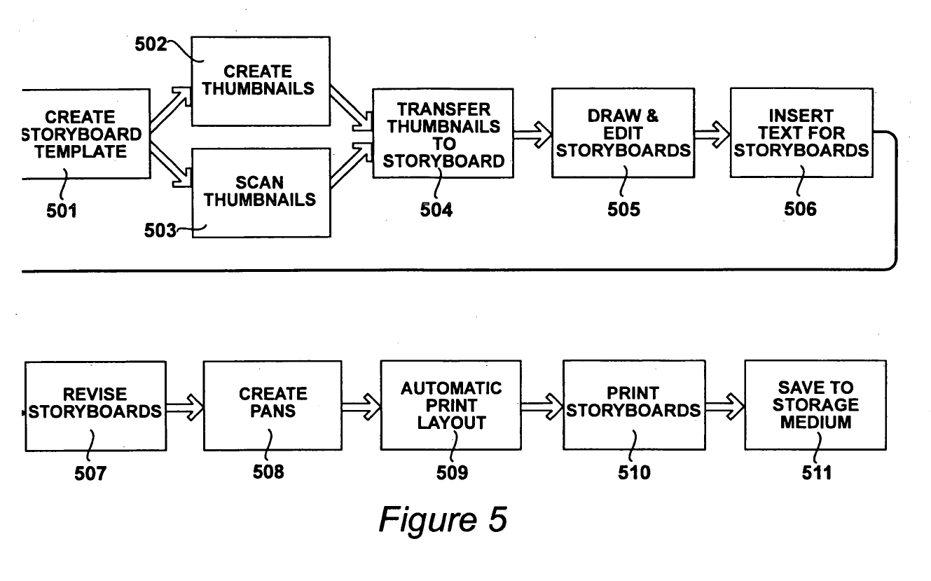

In an embodiment of the present invention, for the creation of storyboard sequences, a new template is generated in the digital domain on a computer system. Existing thumbnails or individual paper storyboard component drawings are scanned in, or similar drawing is performed digitally within the storyboarding system as shown in FIG. 5.

In an embodiment, storyboards are created at step 501 and stored as a sequence of frames in the computer system, wherein the length of such sequences is, for all practical purposes, substantially infinite. Previously, the length of storyboarding sequences in inventions having the capacity to allow both direct digital creation of artwork and incorporation of scanned drawings or photos has been limited to a single frame, due to the inability of existing commercial art software to handle multi-frame data.

In the embodiment, thumbnail drawings are created at step 502 or scanned at step 503 into the system. Thumbnails are then placed into the storyboarding template at step 504. A substrate (paper-color) removal algorithm may be used to remove the white background from scanned images.

The thumbnails are then digitally “cleaned up” and transformed into storyboards at step 505 using digital drawing tools on the system. Text indicating dialog, actions, camera pan image names, as well as scene, panel, and timing data may be entered for each storyboard at step 506. Storyboard “timing” for each image panel comprising the storyboard may be entered in “feet and frames” (actual film length) or “seconds and frames (time.)

Storyboards may then be revised at step 507 in a non-linear fashion, this including adding and striking out frames. In an aspect of the invention, frame numbering may be preserved despite the removal or addition of frames by the implementation of special Revision or Pan Revision storyboard panels which permit a departure from the default number pattern. Blank panels may be added for comments, notes, and sketches.

Using a camera pan creation template tool, separate camera pans may be added at step 508, allowing representation of smooth camera movement over a broader image scene (pan image) during the course of a specified time.

In the embodiment, storyboards may be automatically configured, collated and formatted at step 509 for printing in either horizontal of vertical page format, according to a wide variety of parameters. Such resulting storyboards are then printed out onto paper for review at step 510.

At any stages of (images) workflow, storyboard sequence data may be stored in a definition-independent format at step 511 either on the hard disk of a computer system upon which the processing procedures are taking place, or remotely such as by means of a storage system connected to the computer system via a network. Configuration information relating to the setup of the sequence may also be stored.

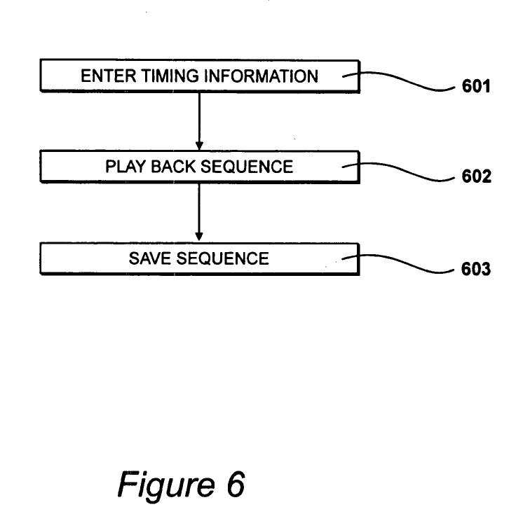

According to a further aspect of the invention, and illustrated in FIG. 6, there is provided a method by which the user enters timing data at step 601 for each frame in the storyboard sequence, and also optionally loads a digital soundtrack into the system. With such frame-timing data, the user is able to play back the storyboards in sequence at step 602, with accurate timing, and optionally, sound, to produce an animated movie. Such a movie (“animatic”) can be used as a low-resolution timing-accurate representation of the final production. The resultant video sequence can be saved in any digital file format at step 603.

By automatically interpolating camera position indications provided by built-in templates, the system may also generate auto-interpolated camera animation for the animatic sequence referenced above, this through the generation of keyframe data based on the timing data entered by the user. Pre-defined templates are utilised for storyboard generation at step 701. The templates incorporate camera position information. An “animatic” sequence is assembled at step 702, that comprises a timing-accurate pre-set sequence of images. It can also optionally include audio data. Camera position keyframes are automatically generated on a per-frame basis from the pre-defined template at step 703. At step 704 the resultant sequence is played back with accurate timing. The resultant camera animation is saved in tandem with the videoaudio sequence in any digital file format at step 705.

1. A method of generating an image sequence, in which image elements are defined digitally, said method comprising the steps of:
a. defining the format of the image via a template system;
b. generating thumbnail image data;
c. transferring such thumbnail data into sequential storyboard panels for reference;
d. one of:
i. drawing resultant storyboards, and
ii. editing resultant storyboards;
e. inserting text for each storyboard;
f. revising storyboards while preserving numbering;
g. creating custom camera pans by employing both template presets and user input;
h. formulating automatic page layout based on a variety of pre-set templates;
i. printing said storyboards; and
j. storing digital image data from the process in an image data format.

2. A method according to claim 1, including the step of generating a plurality of said input images.

3. A method according to claim 1, wherein the aforementioned steps form a chain of processing stages, and further including the step of saving configuration data for said chain of processing stages.

4. A method according to claim 1, wherein said step of generating thumbnail image data takes place by scanning in existing storyboards.

5. A method according to claim 1, wherein said step of generating thumbnail image data takes place by drawing digitally directly into a computer system.

6. A method according to claim 1, wherein said step of revising storyboards comprises adding storyboard panels in to the sequence.

7. A method according to claim 1, wherein said step of revising storyboards comprises removing storyboard panels from the sequence.

8. A method according to claim 1, wherein said step of defining the format of the image via a template system is carried out first.

9. An apparatus for generating an image sequence, in which image elements are defined digitally, comprising:
a. a definer defining first a format of an image via a template system;
b. a generator generating thumbnail data;
c. a transferor for transferring said thumbnail data into sequential storyboard panels for reference;
d. drawing tools for one of:
i. drawing or editing resultant storyboards, and
ii. editing resultant storyboards;
e. an inserter for insertion of text for each storyboard;
f. revisors for revising storyboards while preserving numbering and adding/removing storyboards in the sequence;
g. a creator for creating camera pans from a variety of template presets;
h. a page layouter for automatically laying out pages based on a variety of pre-set templates;
i. a print mechanism for printing said storyboards; and
j. a storer for storing digital image data from the process in an image data format.

10. Apparatus according to claim 9, wherein said generator generates thumbnail data by scanning in existing storyboards.

11. Apparatus according to claim 9, wherein said generator generates thumbnail data by drawing digitally directly into a computer system.

12. Apparatus according to claim 9, wherein said drawing tools comprise digital drawing and image processing tools for enhancing and coloring storyboard image content.

13. A computer-readable medium dependent on claim 1 and having computer-readable instructions executable by a computer such that, when executing said instructions, a computer will perform the method steps of claim 1.

14. Instructions dependent on claim 1 and executable by a computer such that when executing said instructions said computer will perform the steps of claim 1.

15. A method of generating a video sequence, said method comprising the steps of:
a. entering timing information for each frame of a storyboard sequence, indicating a total length that each storyboard thereof should be displayed;
b. playing back a resultant sequence with accurate timing; and
c. saving out a resultant video sequence in any digital file format.

16. A method according to claim 15, further comprising the step of loading audio data to match a sequence of images, providing a combined audio-video file for accurate visual timing reference.

17. A method according to claim 1 for automatic generation of camera pans, based on camera position indicators, said method comprising the steps of:
a. utilizing pre-defined templates for storyboard generation, pre-defined templates incorporating camera position information;
b. assembling an “animatic” sequence by the method according to claim 1, comprising a timing-accurate pre-set sequence of images;
c. automatically generating camera position keyframes;
d. playing back a resultant sequence with accurate timing; and
e. saving resultant camera animation in tandem with a video-audio sequence in any digital file format.

18. A method according to claim 17, wherein said pre-defined templates incorporate camera position information.

19. A method according to claim 17, wherein said “animatic” sequence further comprises audio data.

20. A method according to claim 17, wherein said camera position keyframes are generated on a per-frame basis from the pre-defined template.
